(19) United States
(12) Patent Application Publication
(10) Pub. No.: US 2004/0132872 A1
(43) Pub. Date: Jul. 8, 2004

(54) Dispersion powders containing optical brighteners, method for the production and the utilization thereof

(76) Inventors: Wolfgang Fiedler, Eppstein (DE); Ludwig Schmitz, Burstadt (DE)

Correspondence Address: MUSERLIAN AND LUCAS AND MERCANTI, LLP, 475 PARK AVENUE SOUTH, NEW YORK, NY, 10016, US

(21) Appl. No.: 10/475,242

(22) PCT Filed: May 2, 2002
(86) PCT No.: PCT/EP02/04785

(30) Foreign Application Priority Data
May 5, 2001 (DE) 101 21 886.9

(51) Int. Cl. C08K 5/34

(52) U.S. Cl. 524/47; 524/86

(57) ABSTRACT

The invention relates to a dispersion powder containing: a) at least one emulsion polymer from the group consisting of vinyl ester, vinyl ester/ethylene vinyl chloride, (meth)acrylate, styrene/acrylate homopolymers or copolymers; b) 0 to 35 percent by weight in relation to the overall mass of the polymer, of at least one spray adjuvant; c) 0.001 to 3 percent by weight, in relation to the overall mass of the polymer, of at least one water-soluble or water-insoluble optical brightener and d) 0 to 25 percent by weight, in relation to the overall mass of the polymer, of at least one anticaking agent. The invention also relates to a method for the production of said dispersion powder and to the utilization thereof.

The present invention relates to dispersion powders comprising optical brighteners to enhance their whiteness, to processes for preparing them, and to their use.

Owing to the polymerization process, polymeric binders contain impurities which induce an unwanted yellowish discoloration in the film that results after drying. Additionally, these binders comprise additives, such as defoamers or preservatives, for example, which likewise induce a yellow color in the film after drying.

Owing to their composition, comprising the polymer and also spraying aids and anticaking agents, dispersion powders in particular frequently possess an intense yellow coloration. The same applies to the films resulting from redispersion of these powders. This inherent color is undesirable on esthetic grounds, however, in many of the fields in which this class of product is employed: for example, as an additive to wallpaper pastes or hydraulically setting compositions based on gypsum or white cement.

It was an object of the present invention, therefore, to provide dispersion powders which possess high whiteness both in their as-supplied form and as an applied redispersion film.

The present invention accordingly provides dispersion powders comprising

a) at least one emulsion polymer from the group consisting of vinyl ester, vinyl ester/ethylene, vinyl chloride, (meth)acrylate, and styrene/(meth)acrylate homopolymers and copolymers,

b) from 0 to 35% by weight, preferably from 3 to 30% by weight, based on the total mass of the polymer, of at least one spraying aid,

c) from 0.001 to 3% by weight, preferably from 0.01 to 1 % by weight, based on the total mass of the polymer, of at least one water-soluble or water-insoluble optical brightener, and

d) from 0 to 25% by weight, preferably from 1 to 15% by weight, based on the total mass of the polymer, of at least one anticaking agent.

Preference is given to dispersion powders comprising

a) an emulsion polymer from the group consisting of vinyl ester, vinyl ester/ethylene, vinyl chloride, (meth)acrylate, and styrene/(meth)acrylate homopolymers and copolymers,

b) from 0 to 35% by weight, preferably from 3 to 30% by weight, based on the total mass of the polymer, of a spraying aid,

c) from 0.001 to 3% by weight, preferably from 0.01 to 1% by weight, based on the total mass of the polymer, of a water-soluble or water-insoluble optical brightener, and

d) from 0 to 25% by weight, preferably from 1 to 15% by weight, based on the total mass of the polymer, of an anticaking agent.

As emulsion polymers a) it is possible to use all known vinyl ester, vinyl ester/ethylene, vinyl chloride, (meth)acrylate, and styrene/(meth)acrylate homopolymers and copolymers.

Preferred emulsion polymers are vinyl ester polymers. Particularly preferred in this context are vinyl acetate homopolymers or copolymers of vinyl acetate with ethylene and/or other vinyl esters, such as vinyl propionate, vinyl pivalate, vinyl esters of ®Versatic acid 9,10, 11 (resolution, α,α,α-trialkyl-branched carboxylic acids, ®VeoVa9 to 11), vinyl chloride, vinyl 2-ethylhexanoate and/or esters of acrylic acid and/or methacrylic acid with straight-chain, branched or cyclic alcohols having from 1 to 22 carbon atoms, preferably from 1 to 12 carbon atoms.

The fraction of emulsion polymer in the dispersion powder is preferably in the range from 40 to 99% by weight, with particular preference in the range from 60 to 95% by weight, and in particular in the range from 70 to 95% by weight, based in each case on the total mass of the dispersion powder.

The polymers are preferably stabilized during their actual preparation by means of protective colloids and/or emulsifiers. As protective colloids it is preferred to use starch derivatives and polyvinyl alcohols. Starch derivatives used are preferably hydrolytically and/or thermally degraded starches, known as dextrins. The polyvinyl alcohols possess a degree of polymerization of preferably from 200 to 3500, with particular preference from 500 to 3000. The degree of hydrolysis is preferably from 80 to 98 mol % and with particular preference from 85 to 95 mol %.

As spraying aid b) it is possible, as well as the protective colloids already mentioned, preferably dextrins and polyvinyl alcohols, to use formaldehyde condensates which are likewise water soluble. Examples of suitable formaldehyde condensates include naphthalenesulfonic acid-formaldehyde, phenolsulfonic acid-formaldehyde, and melaminesulfonic acid derivatives. The different spraying aids may also be added as mixtures to the emulsion polymers.

The yellow coloration of the dispersion powder may be produced both by the protective colloids used to prepare the corresponding dispersions and by the addition of the spraying aids. Degradation products produced during free-radical polymerization may bring about the yellow coloration as well.

As yellow coloration reducer in the dispersion powders it is possible in principle, in accordance with the invention, to use all known and commercially customary optical brighteners.

Optical brighteners are, as is known, organic substances which comprise systems of conjugated double bonds or multiple bonds, possibly including heteroatoms as well, and possessing fluorescence properties. On exposure to light, the molecules absorb invisible ultraviolet light (up to 380 nm) and emit visible blue light (approximately 450 nm). Optical brighteners are used wherever a disruptive yellow tinge in the color of a substrate is caused by absorption of shortwave visible light on or in the substrate. The bluish fluorescent emission of the optical brightener ensures that the blue component which is absorbed by the substrate, and is therefore missing from the reflective light of the yellowish substrate, is supplemented, so giving a gleaming white material. Excessive amounts of optical brightener may, however, result in a blue tinge to the material.

Optical brighteners are used in particular for paper, for textiles, and in laundry detergents.

Compounds used with preference as optical brighteners c) are derivatives of stilbene, coumarin, 1,3-diphenylpyrazoline, naphthalimide, and benzoxazole, especially stilbene derivatives and benzoxazole derivatives. Both water-soluble and water-insoluble derivatives may be used. Water-insoluble optical brighteners are frequently used in the form of aqueous emulsions. Corresponding products are known to the skilled worker. In order to provide improved whitening results, it is necessary to heat water-insoluble optical brighteners or their emulsions, the temperatures used being between 40 and 90° C., preferably between 45 and 75° C.

Water-soluble optical brighteners, on the other hand, may be added directly to the dispersion at room temperature and mixed.

Preferred anticaking agents d) are aluminum silicates, calcium carbonates and magnesium carbonates and/or mixtures thereof, silicas or combinations of dolomite and/or calcite and talc. The anticaking agents preferably possess a particle size of from 0.001 to 0.5 mm.

The dispersion powder may where appropriate further comprise additives from the group consisting of cement fluidifiers, such as melamine-formaldehyde condensates, for example, wetting agents, such as alkyl polyglycols, for example, plasticizers, such as dibutyl phthalate, for example, dispersion defoamers, such as polyethersiloxanes, for example, and preservatives, such as isothiazolinols, for example.

The emulsion polymer a) is prepared in accordance with conventional techniques, preferably by emulsion polymerization of the corresponding monomers using a free-radical initiator.

The dispersion powders of the invention are prepared preferably by spray-drying a dispersion mixture comprising the emulsion polymer a), the spraying aid b), and the optical brightener c) in a spraying tower. Spraying takes place preferably using a two-fluid nozzle or a rotary disc at a drying gas temperature of between 100 and 180° C. In order to increase the stability on storage and the flowability of the dispersion powder, it is preferred to introduce an anticaking agent d) in parallel with the dispersion into the spraying tower, so that there is preferential deposition of the anticaking agent onto the dispersion particles.

The invention provides readily dispersible white dispersion powders which are especially suitable for use in wallpaper pastes and also in compositions comprising gypsum and white cement.

Generally speaking, the addition of dispersion powders to wallpaper pastes makes these pastes easier to use and increases the bond strength. Addition to mortars, concrete or gypsum compositions raises the flexural tensile strength, compressive strength, and tensile adhesive strength of the set construction material.

The invention is described in more detail below with reference to examples without, however, being restricted as a result. The parts and percentages in the examples are by weight based on the respective solids content of the reagents used, unless specified otherwise.

### EXAMPLES

Dispersion 1

A 3 l glass flask located in a heating bath and equipped with stirrer, reflux condenser, dropping funnel and thermometer is charged with 660 parts of fully deionized (DI) water. With stirring (130 rpm),

345 parts of yellow dextrin (®Tackidex DF165, Roquette)

3 parts of sodium lauryl sulfate (®Texapon K12, Cognis)

21 parts of an ethoxylated fatty alcohol containing 20 EO groups (®Genapol O-200, Clariant)

2 parts of a defoamer based on a combination of vegetable oils, modified fatty substances, nonionic emulsifiers, and a very small amount of silicone oil (®Agitan 301, Münzing-Chemie)

5.5 parts of sodium acetate

are added and the mixture is heated to an internal temperature of 65° C. (polymerization liquor). Furthermore, a solution (initiator solution 1) composed of

13.8 parts of tert-butyl hydroperoxide, 70% (Trigonox A-W70, Akzo) in 55 parts of DI water

and a solution (initiator solution 11) composed of

6.9 parts of sodium hydroxymethanesulfinate (®Rongalit C, BASF) in 73 parts of DI water

are prepared. 1380 parts of vinyl acetate are provided as monomer. 138 parts of vinyl acetate are added to the polymerization liquor heated to an internal temperature of 65° C. As soon as the internal temperature has reached 65° C. again, 7 parts of initiator solution I and 8 parts of initiator solution II are added and initial polymerization is carried out for 15 minutes.

Subsequently, the entire amount of vinyl acetate is metered in over the course of 4 hours and, in parallel therewith, initiator solutions I and II are metered in over the course of 5 hours, at 65° C. The batch is then cooled.

The dispersion thus prepared possesses a solids content of 67.5% with a viscosity of 920 mPas (according to Haake, at D=17.93 s⁻¹).

### Example 1

0.5 g of ®Hostalux ETB-N (aqueous emulsion of benzoxazolyl-styryl derivatives, solids content approximately 15%, manufacturer: Clariant) is added to 500 g of dispersion 1 and the mixture is stirred at 50° C. for one hour. A spray viscosity of 400 mPas (according to Haake, at D=17.93 s⁻¹) is then set by adding water. The mixture is sprayed using a two-fluid nozzle. In the course of spraying an anticaking agent, composed of talc and dolomite, is added such that the fraction of the anticaking agent in the dispersion powder is 10% by weight. A storage-stable, readily free-flowing powder is obtained.

### Example 2

Example 1 is repeated but with heating at 70° C. for one hour.

### Example 3

Example 2 is repeated but using 1.0 g of ®Hostalux ETB-N.

### Example 4

0.2 g of ®Leukophor BLB (aqueous solution of a stilbene derivative, solids content approximately 20%, manufacturer: Clariant) is added to 500 g of dispersion 1 and the mixture is stirred for one hour. A spray viscosity of 400 mPas (according to Haake, at D=17.93 s⁻¹) is then set by adding water. The mixture is sprayed using a two-fluid nozzle. In the course of spraying, an anticaking agent composed of talc and dolomite is added such that the fraction of the anticaking agent in the dispersion powder is 10% by weight. A storage-stable, readily free-flowing powder is obtained.

### Example 5

Example 4 is repeated but with 0.4 g of ®Leukophor BLB.

### Comparative Example 1

By adding water to the dispersion 1 described above, a spray viscosity of 400 mPas (according to Haake, at D=17.93 s⁻¹) is then set by adding water. The mixture is then sprayed using a two-fluid nozzle. In the course of spraying an anticaking agent, composed of talc and dolomite, is added such that the fraction of the anticaking agent in the dispersion powder is 10% by weight. A storage-stable, readily free-flowing powder is obtained.

Measurement Method

The yellowing is determined in accordance with DIN 6167 using a Tricolor LFM 3 colorimeter from Dr. Lange & Co. The test dispersion powders are measured without further pretreatment. The resulting measurement is the yellowness index (YI), the corresponding products being classified as follows:

| | |
|---|---|
| YI: 0-10 | White product |
| YI: 10-30 | Yellow-tinged product |
| YI: >30 | Severely yellow product |

Results

Measurement of the above dispersion powders gives the following results:

| | Yellowness Index |
|---|---|
| Example 1 | 6 |
| Example 2 | 5 |
| Example 3 | 2 |
| Example 4 | 8 |
| Example 5 | 6 |
| Comparative example | 12 |
| 1 | |

Dispersion 2

Vinyl acetate-VeoVa10-butyl acrylate dispersion having a solids content of 50%, stabilized with polyvinyl alcohol and prepared in analogy to Example 1 of EP-A-0 761 697.

### Example 6

250 g of a 25% strength solution of a naphthalenesulfonic acid-formaldehyde condensate (®Atlox 4843 from ICI) and 2 g ®Hostalux ETB-N (aqueous emulsion of benzoxazolyl-styryl derivatives, solids content approximately 15%, manufacturer: Clariant) is added to 1000 g of dispersion 2 and the mixture is stirred at 70° C. for one hour. A spray viscosity of 400 mPas (according to Haake, at D=17.93 s⁻¹) is then set by adding water. The mixture is sprayed using a two-fluid nozzle. In the course of spraying, an anticaking agent composed of talc and dolomite is added such that the fraction of the anticaking agent in the dispersion powder is 15% by weight. A storage-stable, readily free-flowing powder is obtained.

### Comparative Example 2

Example 6 was repeated but without adding 5Hostalux ETB-N.

Measurement Method

The yellowing is determined in accordance with DIN 6167 using a Microcolor 2 colorimeter from Dr. Lange & Co. The test dispersion powders are measured without further pretreatment. The resulting measurement is the yellowness index (YI), the corresponding products being classified as follows:

| | |
|---|---|
| YI: 0-3 | White product |
| YI: 4-7 | Yellow-tinged product |
| YI: >7 | Severely yellow |
| | product |

Results

Measurement of the above dispersion powders gives the following results:

| | Yellowness Index |
|---|---|
| Example 6 | 3 |
| Comparative Example | 11 |
| 2 | |

As the examples show, the addition of optical brighteners results in a marked reduction in the yellowing of the dispersion powders.

What is claimed is:

1. A dispersion powder comprising
a) at least one emulsion polymer from the group consisting of vinyl ester, vinyl ester/ethylene, vinyl chloride, (meth)acrylate, and styrene/acrylate homopolymers and copolymers,
b) from 0 to 35% by weight based on the total mass of the polymer, of at least one spraying aid,
c) from 0.001 to 3% by weight based on the total mass of the polymer, of at least one water-soluble or water-insoluble optical brightener, and
d) from 0 to 25% by weight based on the total mass of the polymer, of at least one anticaking agent.

2. The dispersion powder as claimed in claim 1, characterized in that the emulsion polymer a) is a vinyl acetate copolymer.

3. The dispersion powder as claimed in claim 1 or 2, characterized in that the emulsion polymer a) is stabilized by means of protective colloids and/or emulsifiers.

4. The dispersion powder as claimed in claim 3, characterized in that a starch derivative from the group consisting of hydrolytically and/or thermally degraded starches is used as protective colloid.

5. The dispersion powder as claimed in claim 3, characterized in that a polyvinyl alcohol having a degree of polymerization of from 200 to 3500 and a degree of hydrolysis of from 80 to 98 mol % is used as protective colloid.

6. The dispersion powder as claimed in at least one of the preceding claims, characterized in that starch derivatives from the group consisting of hydrolytically and/or thermally degraded starches, polyvinyl alcohols and/or water-soluble formaldehyde condensates are used as spraying aid b).

7. The dispersion powder as claimed in at least one of the preceding claims, characterized in that stilbene derivatives and/or benzoxazole derivatives are used as optical brighteners c).

8. The dispersion powder as claimed in at least one of the preceding claims, characterized in that the optical brightener c) may be either water-soluble or else water-insoluble.

9. The dispersion powder as claimed in at least one of the preceding claims, characterized in that aluminum silicates, calcium carbonates and magnesium carbonates or mixtures thereof, silicas and combinations of dolomite and/or calcite and talc are used as anticaking agents d).

10. A process for preparing a dispersion powder as claimed in at least one of the preceding claims by mixing at least one emulsion polymer a), stabilized if desired by a protective colloid and/or emulsifier, with, if desired, at least one spraying aid b) and at least one optical brightener c) and then drying the resulting mixture, if desired with simultaneous admixing of at least one anticaking agent d).

11. The process as claimed in claim 10, characterized in that the mixture is spray-dried.

12. The use of a dispersion powder as claimed in at least one of claims 1 to 9 for modifying wallpaper paste, mortar or concrete.
